(19) United States
(12) Patent Application Publication
(10) Pub. No.: US 2018/0283305 A1
(43) Pub. Date: Oct. 4, 2018

(54) ENGINE SYSTEM

(71) Applicant: TOYOTA JIDOSHA KABUSHIKI KAISHA, Toyota-shi (JP)

(72) Inventor: Shigeyuki URANO, Gotemba-shi (JP)

(73) Assignee: TOYOTA JIDOSHA KABUSHIKI KAISHA, Toyota-shi (JP)

(21) Appl. No.: 15/889,672

(22) Filed: Feb. 6, 2018

(30) Foreign Application Priority Data
Apr. 4, 2017 (JP) 2017-074436

(51) Int. Cl. F02D 41/14; F02D 41/30; F02D 41/40

(52) U.S. Cl. CPC F02D 41/1498; F02D 2041/389; F02D 41/401; F02D 41/3035

(57) ABSTRACT

A control device for an internal combustion engine according to the present application takes in and processes a signal of a knock sensor, and acquires a timing at which a significant change appears in the signal of the knock sensor from a result of the signal processing. The control device calculates a self-ignition start timing of regular combustion based on the timing at which the significant change appears in the signal of the knock sensor. The calculated self-ignition start timing is used in determination of an operation amount of an actuator for controlling an operation of the internal combustion engine, for example, a fuel injection timing.

### CROSS-REFERENCE TO RELATED APPLICATION

The present application claims priority under 35 U.S.C. § 119 to Japanese Patent Application No. 2017-074436, field Apr. 4, 2017. The contents of this application are incorporated herein by reference in their entirety.

### BACKGROUND

Preferred embodiments relate to a control device for an internal combustion engine, and in particular to a control device for an internal combustion engine that causes premixed gas to burn by self-ignition.

In order to control combustion efficiency, noise, and emission such as NOx in the internal combustion engine that causes premixed gas to burn by self-ignition, it is effective to control a self-ignition start timing. In order to properly control the self-ignition start timing, it is necessary to estimate a self-ignition start timing at present with high precision. Information concerning a self-ignition start timing can be obtained with high precision by using an in-cylinder pressure sensor, for example. However, an in-cylinder pressure sensor is relatively expensive, and practical application of an in-cylinder pressure sensor has several problems. Consequently, it is studied to estimate a self-ignition start timing by using a vibration sensor that is already loaded generally at present, more specifically, a knock sensor. For example, JP2007-127004A discloses detecting occurrence of self-ignition combustion by a knock sensor and estimating the start timing.

However, JP2007-127004A does not describe how to use the signal of the knock sensor to estimate the self-ignition start timing. In the case of detecting knock by using the signal of a knock sensor in a spark-ignition engine, the timing at which an amplitude of the signal of the knock sensor becomes maximum is generally regarded as a knock occurrence timing. In the same way as this, as for the self-ignition start timing of an internal combustion engine that causes premixed gas to burn by self-ignition, it is conceivable as one method to estimate the timing at which the amplitude of the signal of the knock sensor becomes maximum as the self-ignition start timing.

However, as the result that the inventor of the present application performed an experiment and investigated the relationship between the timing at which the amplitude of the signal of the knock sensor becomes maximum and the self-ignition start timing, it has been found out that correlation between both of them is not high enough to estimate the self-ignition start timing with high precision, although a certain correlation is found between both of them.

### SUMMARY

Preferred embodiments address the problem as described above, and have an object to provide a control device for an internal combustion engine that can estimate a self-ignition start timing of the internal combustion engine that causes premixed gas to burn by self-ignition with high precision by using a signal of a knock sensor.

A control device for an internal combustion engine according to preferred embodiments causes premixed gas to burn by self-ignition, and is configured to take in and process a signal of a knock sensor attached to the internal combustion engine. In order to attain the above described object, the present control device includes self-ignition start timing calculation means that calculates a self-ignition start timing based on a timing at which a significant change appears in the signal of the knock sensor, and actuator operation amount determination means that determines an operation amount of an actuator for controlling an operation of the internal combustion engine based on the self-ignition start timing. The present control device is a computer including at least one processor and at least one memory. The present control device is configured to function as the self-ignition start timing calculation means and the actuator operation amount determination means by a program stored in a memory being executed by a processor.

Regular self-ignition combustion in the internal combustion engine which causes premixed gas to burn by self-ignition is abrupt in combustion as compared with flame propagation in a spark-ignition engine. When a pressure wave that occurs at a start timing of the abrupt combustion is transmitted to the knock sensor as vibration, the vibration is detected as a significant change in the signal of the knock sensor. The significant change of the signal of the knock sensor is a change that can be distinguished from a change of the signal by a disturbance. In the case of the internal combustion engine that causes premixed gas to burn by self-ignition, irregular self-ignition combustion hardly occurs unlike a spark-ignition engine. That is, when a change of the signal that can be distinguished from a change of the signal by a disturbance appears, the change of the signal is a change by vibration that occurs at the start timing of self-ignition combustion.

As a result that the inventor of the present application performed an experiment, and investigated the relationship between the timing at which a significant change appears in the signal of the knock sensor and the self-ignition start timing, it has been confirmed that there is a high correlation between the timing at which a significant change appears in the signal of the knock sensor and the self-ignition start timing. This means that a self-ignition start timing can be estimated with high precision by acquiring the timing at which a significant change appears in the signal of the knock sensor.

As described above, the present control device is configured to calculate a self-ignition start timing based on the timing at which a significant change appears in the signal of the knock sensor. Consequently, according to the present control device, the self-ignition start timing can be estimated with high precision, and control precision of the internal combustion engine can be enhanced by determining the operation amount of the actuator for controlling the operation of the internal combustion engine based on the self-ignition start timing estimated with high precision.

As a method for detecting a significant change appearing in the signal of the knock sensor, a method of comparing a magnitude of the signal of the knock sensor with a predetermined threshold value may be used. For example, a timing at which the magnitude of the signal of the knock sensor exceeds the predetermined threshold value may be acquired as the timing at which a significant change appears in the signal of the knock sensor. Since self-ignition combustion is abrupt, a signal by a disturbance and a signal by vibration of the self-ignition combustion can be clearly distinguished based on a threshold value. Note that the threshold value may be changed in accordance with parameters indicating an operating state of the internal combustion engine, for example, target torque and an engine speed.

In order to distinguish the signal by a disturbance and a signal by vibration of self-ignition combustion more accurately, the threshold value may be change in accordance with a level of the disturbance. Specifically, a variation in the signal of the knock sensor in a period in which it is certain that self-ignition combustion does not occur is calculated, and the threshold value may be changed in accordance with the variation of the signal of the knock sensor which is obtained by calculation. The period in which it is certain that self-ignition combustion does not occur is a period in which it is obvious that the conditions of occurrence of self-ignition combustion are not established, for example, and the timing can be predicted in advance. Further, if the timing at which the amplitude of the signal of the knock sensor becomes maximum is known, an approximate self-ignition start timing is known, so that the period in which the variation of the signal of the knock sensor is calculated may be determined with the timing at which the amplitude of the signal of the knock sensor becomes maximum as a reference.

As another method for detecting a significant change appearing in the signal of the knock sensor, a method based on a waveform of the signal of the knock sensor may be used. Specifically, a plurality of maximum points are taken, which are in a period that is at an advance side from a timing at which an amplitude of the signal of the knock sensor becomes maximum, and in a period in which it is certain that self-ignition combustion occurs, in an orthogonal coordinate system with a magnitude of the signal of the knock sensor as a Y axis, and with a crank angle or a time as an X axis. Subsequently, an intersection point of a straight line or a curved line approximating a relationship among the plurality of maximum points and an X axis is obtained, and an X value of the intersection point is acquired as the timing at which the significant change appears in the signal of the knock sensor. In this method, the timing at which the significant change appears in the signal of the knock sensor is estimated by using the signal of the knock sensor after the significant change appears, instead of the signal of the knock sensor before the significant change appears. The signal of the knock sensor after the significant change appears has a high S/N ratio, so that according to the method, an influence of the disturbance on the estimation precision of the self-ignition start timing can be suppressed to be low.

Incidentally, the level of the signal of the knock sensor at the time of self-ignition combustion occurring changes dependently on a combustion speed. Under a high load, the combustion speed is high, and the level of the signal of the knock sensor is high, whereas under a low load, the combustion speed is low, and the level of the signal of the knock sensor is also low. When the level of the signal of the knock sensor becomes low, the significant change appearing in the signal of the knock sensor becomes relatively unclear. Consequently, the self-ignition start timing is calculated based on the timing at which the significant change appears, when a maximum value of an amplitude of the signal of the knock sensor is larger than a predetermined lower limit value, whereas the self-ignition start timing may be calculated based on a timing at which the amplitude of the signal of the knock sensor becomes maximum when the maximum value of the amplitude is the lower limit value or less.

As compared with the correlation between the timing at which a significant change appears in the signal of the knock sensor and the self-ignition start timing, the correlation between the timing at which the amplitude of the signal of the knock sensor becomes maximum and the self-ignition start timing is not high. However, if the timing at which the amplitude of the signal of the knock sensor becomes maximum is used only when the significant change appearing in the signal of the knock sensor is unclear, the operation region in which the actuator operation amount can be determined based on the self-ignition start timing can be enlarged.

Further, as a result that the inventor according to the present application performed an experiment, and investigated an error in the case of calculating the self-ignition start timing based on the timing at which the significant change appears in the signal of the knock sensor, it has been confirmed that when the level of the signal of the knock sensor becomes low, the calculated value of the self-ignition start timing deviates to a delay side from a true value, and the error is larger as the level of the signal of the knock sensor is lower. Consequently, the self-ignition start timing calculated based on the timing at which the significant change appears may be corrected to an advance side when a maximum value of an amplitude of the signal of the knock sensor is a predetermined lower limit value or less, and a correction amount of the self-ignition start timing to an advance side may be made larger, as the maximum value of the amplitude is smaller.

As described above, according to the present control device, the self-ignition start timing of the internal combustion engine that causes premixed gas to burn by self-ignition can be estimated with high precision by calculating the self-ignition start timing based on the timing at which a significant change appears in the signal of the knock sensor.

### BRIEF DESCRIPTION OF DRAWINGS

FIG. 1 is a diagram of a configuration of an engine system according to a first embodiment;

FIG. 2 is a block diagram illustrating functions of a control device configuring the engine system;

FIG. 3 is a diagram illustrating a relationship between a waveform showing self-ignition combustion and a signal of a knock sensor;

FIG. 4 is a graph illustrating a correlation between a self-ignition start timing and a knock amplitude maximum timing;

FIG. 5 is a graph illustrating a correlation between a self-ignition start timing and a knock occurrence timing;

FIG. 6 is a graph illustrating a waveform of a signal of a knock sensor before and after start of self-ignition combustion;

FIG. 7 is a graph expressing a signal of the knock sensor illustrated in FIG. 6 in an absolute value;

FIG. 8 is a flowchart illustrating a routine of a self-ignition start timing feedback control according to the first embodiment;

FIG. 9 is a diagram illustrating a calculation period of the standard deviation for calculating a knock determination threshold value according to a second embodiment;

FIG. 10 is a flowchart illustrating a main routine of self-ignition start timing feedback control according to the second embodiment;

FIG. 11 is a flowchart illustrating a subroutine for acquiring a knock occurrence timing according to the second embodiment;

FIG. 12 is a diagram illustrating a method for calculating a knock occurrence timing according to a third embodiment;

FIG. 13 is a flowchart illustrating a subroutine for acquiring the knock occurrence timing according to the third embodiment;

FIG. 14 is a diagram illustrating difference in level of a knock signal in accordance with operation conditions;

FIG. 15 is a flowchart illustrating a main routine of self-ignition start timing feedback control according to a fourth embodiment;

FIG. 16 is a graph illustrating a relationship between a maximum amplitude of a knock signal and an error of a calculated value of self-ignition timing to a true value;

FIG. 17 is a flowchart illustrating a main routine of a self-ignition start timing feedback control according to a fifth embodiment.

### DESCRIPTION OF EMBODIMENTS

In the following, embodiments will be described with reference to the drawings.

### 1. Configuration of Engine System

First, an engine system to which the embodiments of the present application is applied in each of embodiments mentioned later is described. FIG. 1 is a diagram of a configuration of the engine system. The configuration of the engine system illustrated in the drawing is common to the respective embodiments. The engine system is an engine system for automobile, and is configured by an internal combustion engine 2 and a control device 30. The internal combustion engine 2 is an internal combustion engine that causes premixed gas to burn by self-ignition, more specifically, a self-ignition combustion engine that can take a self-ignition combustion method such as HCCI (Homogeneous Charge Compression Ignition), SACI (Spark Assisted Compression Ignition), PPC (Partially Premixed Compression) and PCCI (Premixed Charge Compression Ignition).

To the internal combustion engine 2, a plurality of sensors including at least a knock sensor 10 and a crank angle sensor 12 are attached. Further, to the internal combustion engine 2, a plurality of actuators for controlling an operation of the internal combustion engine 2 are attached. The actuators include at least a fuel injection device 20. The fuel injection device 20 includes an in-cylinder injection valve that directly injects fuel into a combustion chamber. These sensors and actuators are electrically connected to the control device 30.

The control device 30 is an ECU (Electronic Control Unit) having at least one processor and at least one memory. In the memory, various data including various programs for controlling the internal combustion engine 2 and maps are stored. The programs stored in the memory are loaded and executed by a processor, whereby the control device 30 is caused to realize various functions. To the control device 30, various kinds of information concerning an operating state and operation conditions of the internal combustion engine 2 are inputted from the sensors attached to the internal combustion engine 2. The control device 30 determines operation amounts of the actuators relating to the operation of the internal combustion engine 2 based on at least these kinds of information. Note that the control device 30 may be configured by a plurality of ECUs.

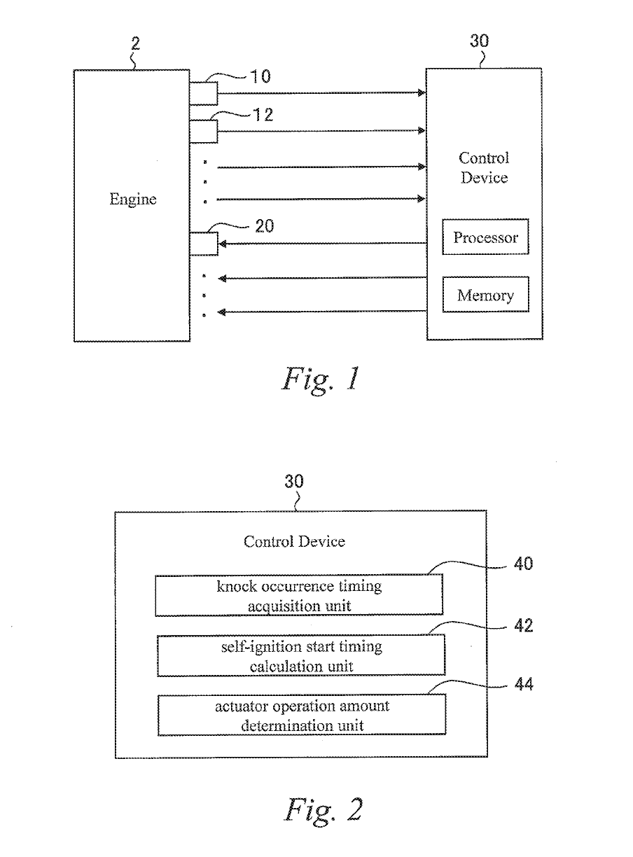

FIG. 2 is a block diagram illustrating functions of the control device 30. In FIG. 2, particularly, a function relating to acquisition of a knock occurrence timing, a function relating to calculation of a self-ignition start timing, and a function relating to determination of an actuator operation amount are extracted, out of various functions of the control device 30, and are expressed in blocks. The control device 30 also includes various other functions, but illustration of these functions is omitted. In FIG. 2, arithmetic operation units 40, 42 and 44 are assigned to the respective functions. However, the respective arithmetic operation units 40, 42 and 44 do not exist as hardware, but are virtually realized when the programs stored in the memory are executed by the processor. The configuration of the control device 30 illustrated in FIG. 2 is common in the respective embodiments, but the functions of the respective arithmetic operation units 40, 42 and 44 are different in each of the embodiments. Therefore, hereunder, outlines of the respective functions of the knock occurrence timing acquisition unit 40, the self-ignition start timing calculation unit 42 and the actuator operation amount determination unit 44 are described, and details are described in each of the embodiments.

### 2. Estimation of Self-Ignition Start Timing Using Signal of Knock Sensor

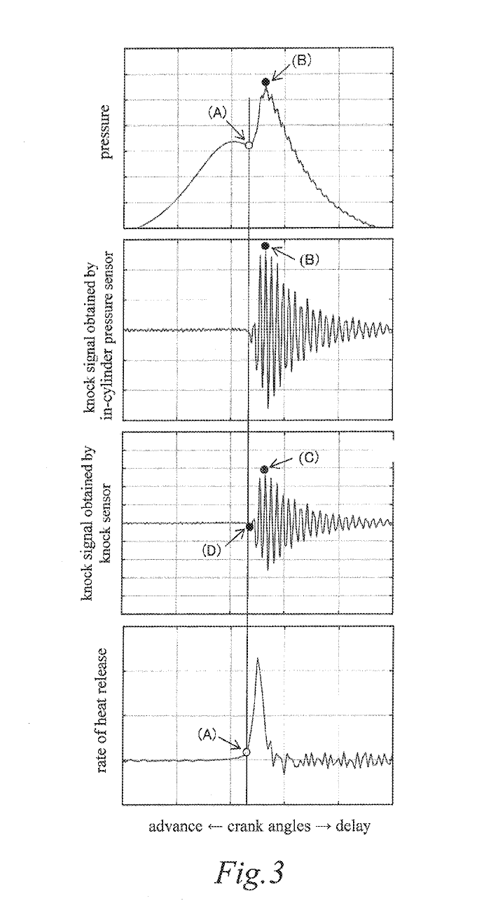

Here, a relationship between a waveform showing self-ignition combustion and a signal of a knock sensor is firstly described by using FIG. 3. FIG. 3 illustrates a result of an experiment relating to self-ignition combustion performed by the inventor according to the present application in a four-tier graph. Note that although the experimented self-ignition combustion is HCCI combustion, the relationship between the waveform showing self-ignition combustion and the signal of the knock sensor described hereunder is a relationship that also applies to the other self-ignition combustion methods such as SACI combustion.

A first tier in FIG. 3 is a graph illustrating a waveform of in-cylinder pressure by self-ignition combustion. A second tier is a graph illustrating a waveform of a knock signal obtained by the in-cylinder pressure sensor. In more detail, the waveform obtained by passing a signal outputted from the in-cylinder pressure sensor through a band-pass filter is illustrated in the graph. The band-pass filter is matched to a primary frequency band (5 to 10 kHz, for example) of knock. A third tier is a graph illustrating a waveform of a knock signal obtained by the knock sensor. In more detail, the waveform obtained by passing the signal outputted from the knock sensor through a band-pass filter having the same frequency band as described above is illustrated in the graph. A fourth tier is a graph illustrating a waveform of a rate of heat release calculated from an in-cylinder pressure.

In the graph, (A) shows a self-ignition start timing. In the graph, (B) shows a timing at which an amplitude of the knock signal obtained from the in-cylinder pressure sensor becomes maximum, that is, a timing at which an amplitude of a pressure variation in a combustion chamber becomes maximum. In the graph, (C) shows a timing at which an amplitude of the knock signal obtained from the knock sensor becomes maximum. In the present description, the timing (C) is referred to as “a knock amplitude maximum timing”. In the graph, (D) shows a timing at which the knock signal obtained from the knock sensor starts to change. The timing (D) is a timing at which occurrence of knock is detected by the knock sensor, so that in the present description, the timing (D) is referred to as “a knock occurrence timing”.

In the case of detecting knock in a spark-ignition engine, the knock amplitude maximum timing (C) is normally used. However, in the self-ignition combustion engine, there is a deviation between the self-ignition start timing (A) and the knock amplitude maximum timing (C). The deviation includes a delay from the self-ignition start timing (A) to the timing (B), that is, a delay until the amplitude of the pressure variation in the combustion chamber becomes maximum after start of self-ignition, and a delay from the timing (B) to the knock amplitude maximum timing (C), that is, a delay until the amplitude of the knock signal obtained by the knock sensor becomes maximum after the amplitude of the pressure variation in the combustion chamber becomes maximum.

Consequently, in order to calculate the self-ignition start timing (A) from the knock amplitude maximum timing (C), it is necessary to correct the above described two kinds of delays. The delay from the timing (B) to the knock amplitude maximum timing (C) is a transmission delay of vibration from the inside of the combustion chamber to an engine block, and therefore is substantially constant when it is converted into time. Correction to the delay can be performed with an influence of an engine speed taken into consideration, because a relationship between time and a crank angle changes in accordance with the engine speed. Meanwhile, the delay from the self-ignition start timing (A) to the timing (B) is considered to be influenced by all elements (a fuel amount, an air amount, an EGR rate, an in-cylinder temperature and a self-ignition timing, for example) relating to the rate of heat release in self-ignition combustion, so that it is not easy to perform correction of the delay properly.

Thus, in the present application, attention is not paid to the knock amplitude maximum timing (C), but to the knock occurrence timing (D). Regular self-ignition combustion in a self-ignition combustion engine is abrupt in combustion as compared with flame propagation in a spark-ignition engine. When a pressure wave that occurs at a start timing of the abrupt combustion is transmitted to the knock sensor as vibration, a significant change appears in the signal of the knock sensor. The knock occurrence timing (D) can be acquired by detecting the significant change. The delay from the self-ignition start timing (A) to the knock occurrence timing (D) is small enough to be ignored as compared with the delay from the self-ignition start timing (A) to the knock amplitude maximum timing (C), and is hardly influenced by the elements relating to the aforementioned rate of heat release. Consequently, it is conceivable that the self-ignition start timing (A) can be estimated with high precision based on the knock occurrence timing (D).

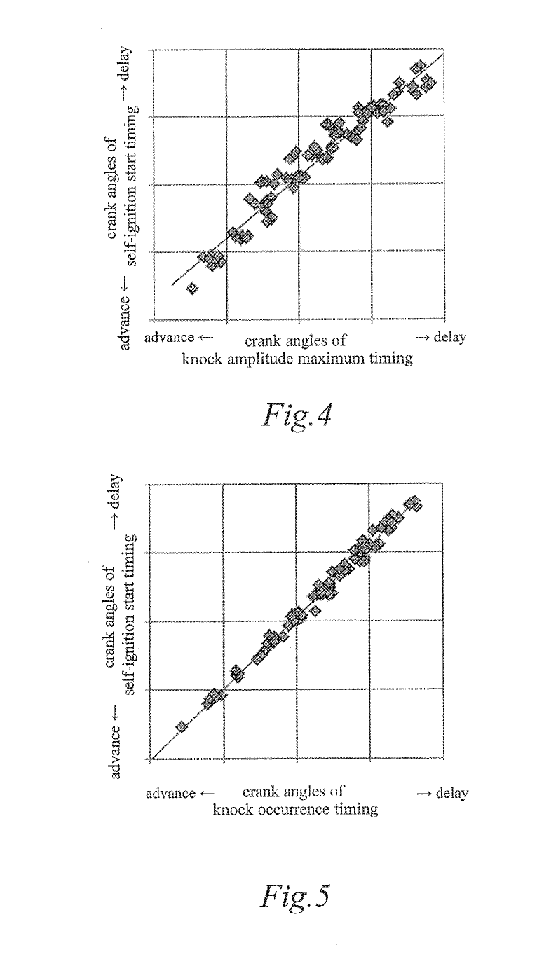

The inventor of the present application performed experiments, and investigated correlations with the self-ignition start timing with respect to the knock amplitude maximum timing and the knock occurrence timing, and the results thereof are illustrated in graphs, respectively. In the experiment, the inventor collected data as illustrated in FIG. 3 with respect to approximately 100 operation points in the case where operation by HCCI combustion was performed while the engine speed, the fuel injection amount, the EOR rate, the air amount and the intake air temperature were changed. FIGS. 4 and 5 are results of specifying the self-ignition start timing, the knock amplitude maximum timing and the knock occurrence timing from the collected data, and plotting the self-ignition start timing, the knock amplitude maximum timing and the knock occurrence timing on the graphs. FIG. 4 illustrates a correlation between the self-ignition start timing and the knock amplitude maximum timing, and FIG. 5 illustrates a correlation between the self-ignition start timing and the knock occurrence timing. Vertical axes of the two graphs both represent crank angles and are equal to each other in scale. Further, horizontal axes of the two graphs both represent crank angles and are equal to each other in scale.

From the graph in FIG. 4, it is found that although a certain correlation is found between the self-ignition start timing and the knock amplitude maximum timing, a variation to an approximate straight line is not small. That is, the correlation between the self-ignition start timing and the knock amplitude maximum timing is not high enough to estimate the self-ignition start timing with high precision from the knock amplitude maximum timing by using the approximate straight line. In contrast to this, from the graph in FIG. 5, it is found that the correlation between the self-ignition start timing and the knock occurrence timing is high, and a variation to the approximate straight line is small. If there is such a high correlation, the self-ignition start timing can be estimated with high precision from the knock occurrence timing by using the approximate straight line.

From the above reason, in the present application, the control device 30 is configured to calculate the self-ignition start timing based on the knock occurrence timing. The knock occurrence timing acquisition unit 40 is means that processes the signal of the knock sensor 10 and acquires the knock occurrence timing, and is configured to acquire the knock occurrence timing by a method of each of the embodiments described later. The self-ignition start timing calculation unit 42 is configured to calculate the self-ignition start timing based on the knock occurrence timing on the precondition of the correlation illustrated in FIG. 5. Note that the knock occurrence timing acquisition unit 40 and the self-ignition start timing calculation unit 42 configure self-ignition start timing calculation means described in claims of the present application.

The calculated self-ignition start timing is used in control of the internal combustion engine 2 by the control device 30. The actuator operation amount determination unit 44 is configured to determine at least one of the actuator operation amounts based on the self-ignition start timing. The actuator operation amounts that can be determined by the actuator operation amount determination unit 44 include the fuel injection amount, the fuel injection timing, the fuel injection pressure, the ignition timing (auxiliary ignition timing in the case of self-ignition combustion being SACI combustion), the air amount, the EGR valve opening degree, intake valve opening and closing timings, exhaust valve opening and closing timings, an ozone supply amount, the intake air temperature, an engine cooling water temperature and fuel properties.

### 3. First Embodiment

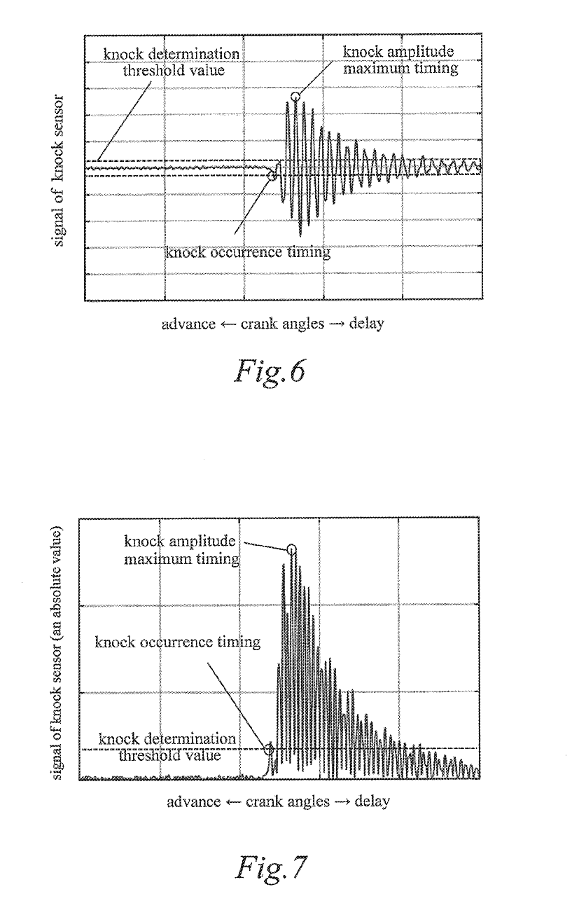

Hereunder, a first embodiment of the present application is described. First, a method for acquiring a knock occurrence timing according to the first embodiment is described with use of FIGS. 6 and 7. FIG. 6 is a graph illustrating a waveform of a signal of a knock sensor before and after start of self-ignition combustion. FIG. 7 is a graph expressing the signal of the knock sensor illustrated in FIG. 6 in an absolute value. As understood from these graphs, when self-ignition combustion occurs, a significant change that can be distinguished from a change of the signal by a disturbance appears in the signal of the knock sensor. As a method for detecting the significant change, a method of comparing a magnitude of the signal of the knock sensor with a predetermined threshold value is used in the first embodiment.

Since self-ignition combustion is abrupt, the signal by a disturbance and a signal by vibration of self-ignition combustion can be clearly distinguished based on a threshold value. In the first embodiment, the magnitude of the signal of the knock sensor (that is, an absolute value of the signal) is compared with a knock determination threshold value, and a timing at which the magnitude of the signal of the knock sensor exceeds the knock determination threshold value is acquired as the knock occurrence timing. The knock determination threshold value may be a constant, but is changed in accordance with the operating state of the internal combustion engine 2 in the first embodiment. Specifically, the knock determination threshold value is calculated with use of a map having target torque (or the fuel injection amount) as input. A level of the signal of the knock sensor becomes smaller as the load is lower, so that in this map, the knock determination threshold value is made smaller as the target torque is smaller. Note that to the input of the map for determining the knock determination threshold value, the engine speed can be also added.

In the first embodiment, the control device 30 determines a target self-ignition start timing based on the operating state of the internal combustion engine 2, and carries out feedback control for causing the self-ignition start timing calculated based on the knock occurrence timing to approach the target self-ignition start timing. By estimating a present self-ignition start timing from the knock occurrence timing and performing feedback control, it becomes possible to control the self-ignition start timing to an intended self-ignition start timing under all situations (under environmental influence of a temperature, atmospheric pressure, humidity and the like, and fuel variation of the market and the like). As a result, it becomes possible to enhance practical fuel efficiency, enhance drivability, and keep exhaust emission properly. Note that as the actuator operation amount relating to the self-ignition start timing feedback control, the fuel injection timing of the fuel injection device 20 is used.

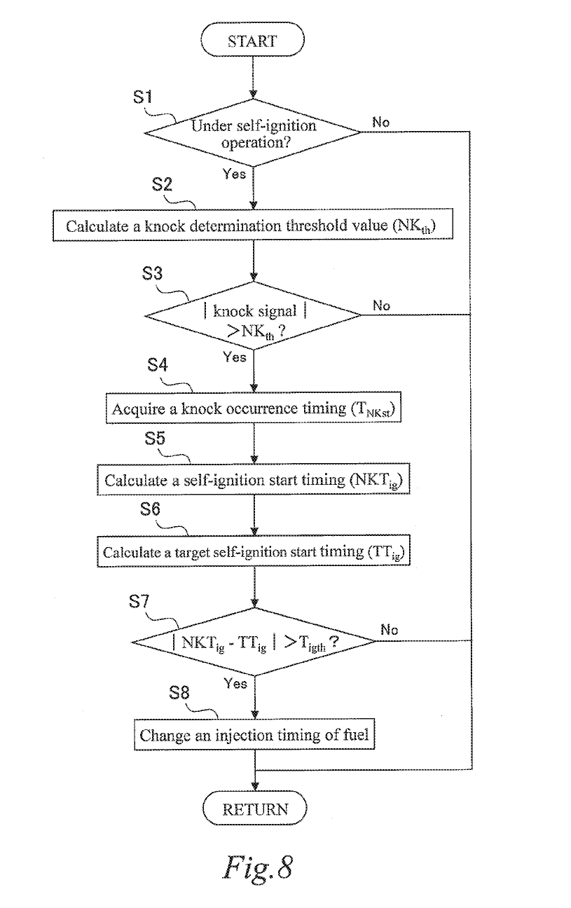

FIG. 8 is a flowchart illustrating a routine of the self-ignition start timing feedback control according to the first embodiment. In the memory of the control device 30 according to the first embodiment, the program corresponding to the routine illustrated in FIG. 8 is stored. The program is executed by the processor, whereby the function for the self-ignition start timing feedback control is given to the control device 30.

In step S1 of the flowchart, it is determined whether or not the internal combustion engine 2 is under self-ignition operation. An operation region in which the self-ignition operation is performed is set in advance. In the step, it is determined whether or not an operation point of the internal combustion engine 2 which is fixed by the engine speed and the target torque is within a self-ignition operation region set in advance. When the internal combustion engine 2 is not under self-ignition operation, the following processing is totally skipped and the present routine is ended.

When the internal combustion engine 2 is under self-ignition operation, processing in step S2 is performed, and subsequently, determination in step S3 is performed. In step S2, a knock determination threshold value (NKₜₕ) is calculated from a map. The map has at least target torque (or a fuel injection amount) as input. In step S3, it is determined whether or not a magnitude of a knock signal, that is, a signal of the knock sensor 10 is larger than the knock determination threshold value. When the magnitude of the knock signal is the knock determination threshold value or less, a significant change that can be distinguished from the change of the signal by a disturbance does not appear in the knock signal. In this case, the following processing is totally skipped, and the present routine is ended.

When the magnitude of the knock signal is larger than the knock determination threshold value, processing from step S4 to step S6 is performed. In step S4, a time point at which the magnitude of the knock signal exceeds the knock determination threshold value is acquired as a knock occurrence timing (T_{NKst}). Note that the processing from step S2 to step S4 is performed by the knock occurrence timing acquisition unit 40.

In step S5, a self-ignition start timing (NKT_{ig}) is calculated based on the knock occurrence timing calculated in step S4. Calculation of the self-ignition start timing is performed by using the following expression, for example. In the expression, α and β are coefficients of the approximate straight line illustrated in FIG. 5. In the expression, f(Engspd) is a term that expresses a transmission delay until the pressure variation in the combustion chamber becomes vibration of the engine block, and is expressed by a function of Engspd (engine speed).

NKT_{ig}=α×T_{NKst}+β+f(Engspd)

In the above described expression, α, β and f (Engspd) are determined by adaptation based on an experimental result using an actual machine. However, a delay from the self-ignition start timing to the knock occurrence timing is very small as compared with the delay from the self-ignition start timing to the knock amplitude maximum timing, so that the knock occurrence timing may be directly regarded as the self-ignition start timing. Note that the processing in step S5 is performed by the self-ignition start timing calculation unit 42.

In step S6, a target self-ignition start timing (TT_{ig}) is calculated based on a map. The map has at least the target torque or the fuel injection amount and the engine speed as input. In the operation region of the internal combustion engine 2, there exist a plurality of regions that differ in performance assigned with priority such as a region where outputting torque is assigned with priority, and a region where reduction of combustion noise is given priority. Since self-ignition start timing influences the performances, the target self-ignition start timing is determined in accordance with the operation region, in step S6.

Next, determination in step S7 is performed. In step S7, a control error between the self-ignition start timing (NKT_{ig}) calculated in step S5, and the target self-ignition start timing (TT_{ig}) calculated in step S6 is calculated, and it is determined whether or not a magnitude of the control error is larger than a predetermined correction control determination threshold value (T_{igth}). The correction control determination threshold value may be a constant, or may be calculated based on a map. Since the influence of the self-ignition start timing changes depending on the operation region, the map for calculating the correction control determination threshold value preferably has the target torque or the fuel injection amount and the engine speed as input. When the magnitude of the control error is the correction control determination threshold value or less, remaining processing is skipped, and the present routine is ended.

When the magnitude of the control error exceeds the correction control determination threshold value, processing in step S8 is performed. In step S8, the injection timing of fuel is changed in accordance with a sign of the control error calculated in step S7. When the control error has a minus sign, that is, the self-ignition start timing advances from the target self-ignition start timing, the injection timing is delayed. When the control error has a plus sign, that is, the self-ignition start timing is delayed from the target self-ignition start timing, the injection timing is advanced. Note that the processing from step S6 to step S8 is performed by the actuator operation amount determination unit 44.

The above routine is executed on a cycle basis for each cylinder of the internal combustion engine 2. However, there is a deviation of one cycle between the processing from step S1 to step S7, and the processing in step S8. A result of the processing from step S1 to step S7 executed in the cycle of this time is reflected in the processing in step S8 that is executed in a cycle of a next time.

### 4. Second Embodiment

Next, a second embodiment of the present application is described. The second embodiment has a feature in a method for acquiring a knock occurrence timing. The second embodiment uses a method of comparing the magnitude of a knock signal with a knock determination threshold value, as the method for acquiring the knock occurrence timing similarly to the first embodiment. However, in the first embodiment, the knock determination threshold value is calculated based on the map, whereas in the second embodiment, the knock determination threshold value is calculated by a different method from the method of the first embodiment.

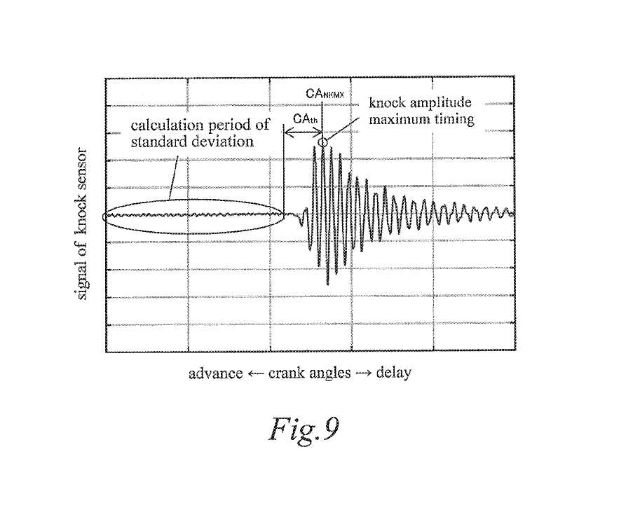

In the second embodiment, in order to distinguish the signal by a disturbance and the signal by vibration of self-ignition combustion more accurately, the knock determination threshold value is changed in accordance with a level of the disturbance. More specifically, the control device 30 according to the second embodiment calculates a standard deviation of the knock signal in a period in which it is certain that no self-ignition combustion occurs. Subsequently, the control device 30 sets a value obtained by multiplying the standard deviation by an integer (for example, 5 to 10×σ, a value that is not exceeded by a variation statistically) as the knock determination threshold value. The period in which it is certain that no self-ignition combustion occurs is a period in which it is obvious that conditions of occurrence of self-ignition combustion are not established, for example. In the second embodiment, as illustrated in FIG. 9, a timing at an advance side from a knock amplitude maximum timing (CA_{NKMX}) by a predetermined period (CAₜₕ) is set as a reference, and a period at the advance side from the timing is set as a calculation period of the standard deviation. The predetermined period is, for example, 30 to 40 deg. Further, when the internal combustion engine 2 is an in-line four-cylinder engine, a start of the standard deviation calculation period is preferably at BTDC 90.

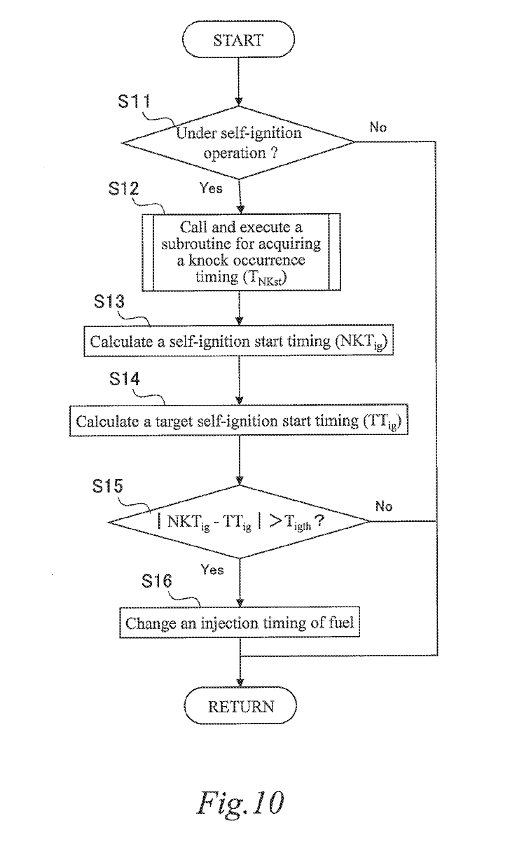

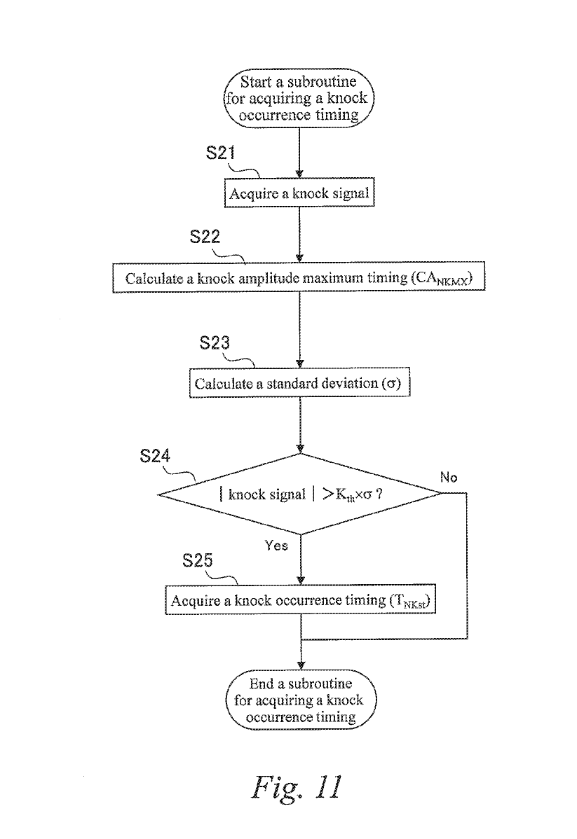

FIG. 10 is a flowchart illustrating a main routine of self-ignition start timing feedback control according to the second embodiment. FIG. 11 is a flowchart illustrating a subroutine for acquiring a knock occurrence timing that is called in the main routine. In the memory of the control device 30 according to the second embodiment, a program corresponding to the main routine illustrated in FIG. 10, and a program corresponding to the subroutine illustrated in FIG. 11 are stored. These programs are executed by the processor, whereby a function for self-ignition start timing feedback control is given to the control device 30.

First, the flowchart of the main routine illustrated in FIG. 10 is described. In step S11 in the flowchart, it is determined whether or not the internal combustion engine 2 is under self-ignition operation. A determination method thereof is as described in step S1 of the flowchart according to the first embodiment. When the internal combustion engine 2 is not under self-ignition operation, the following processing is totally skipped, and the present routine is ended.

When the internal combustion engine 2 is under self-ignition operation, processing from step S12 to step S14 is performed. In step S12, a subroutine for acquiring the knock occurrence timing (T_{NKst}) is called and executed. Details of the subroutine is described later. The processing in step S12 is performed by the knock occurrence timing acquisition unit 40.

In step S13, the self-ignition start timing (NKT_{ig}) is calculated based on the knock occurrence timing calculated in step S12. A calculation method thereof is as described in step S5 in the flowchart according to the first embodiment. Note that the processing in step S13 is performed by the self-ignition start timing calculation unit 42.

In step S14, the target self-ignition start timing (TT_{ig}) is calculated based on the map. The content of the map is as described in step S6 in the flowchart according to the first embodiment.

Next, determination in step S15 is performed. In step S15, a control error between the self-ignition start timing (NKT_{ig}) calculated in step S13 and the target self-ignition start timing (TT_{ig}) calculated in step S14 is calculated, and it is determined whether or not the magnitude of the control error is larger than the correction control determination threshold value (T_{igth}). When the magnitude of the control error is the correction control determination threshold value or less, remaining processing is skipped and the present routine is ended.

When the magnitude of the control error exceeds the correction control determination threshold value, processing in step S16 is performed. The content of the processing is as described in step S8 of the flowchart according to the first embodiment. Note that the processing from step S14 to step S16 is performed by the actuator operation amount determination unit 44.

The above main routine is executed on a cycle basis for each cylinder of the internal combustion engine 2. However, there is a deviation of one cycle between the processing from step S11 to step S15, and the processing in step S16. A result of the processing from step S11 to step S15 which is executed in the cycle of this time is reflected in the processing in step S16 that is executed in a cycle of a next time.

Next, the flowchart of the subroutine illustrated in FIG. 11 is described. In step S21 in the flowchart, a knock signal is acquired from the knock sensor 10. The single knock sensor 10 is basically attached to the engine block, so that the knock signal is acquired at intervals obtained by dividing 720 degrees by the number of cylinders. In the case of a four-cylinder engine, for example, the knock signal is acquired at intervals of 180 degrees. In more detail, the knock signal is acquired with an interval from BTDC 90 deg to ATDC 90 deg as one set.

In step S22, a timing at which an amplitude of the knock signal becomes maximum in the period in which the knock signal is acquired in step S21, that is, the knock amplitude maximum timing (CA_{NKMX}) is calculated.

In step S23, the knock amplitude maximum timing (CA_{NKMX}) calculated in step S22 is set as a reference, and the standard deviation calculation period is determined. The standard deviation calculation period is, for example, from the BTDC 90 to a timing (CAₜₕ) at the advance side by the predetermined period from the knock amplitude maximum timing (CA_{NKMX}). A standard deviation (σ) is calculated by statistically processing the knock signals within the standard deviation calculation period.

In step S24, a value obtained by multiplying the standard deviation (σ) by a constant (Kₜₕ) is calculated as the knock determination threshold value. Subsequently, it is determined whether the magnitude of the knock signal is larger than the knock determination threshold value (Kₜₕ×σ). When the magnitude of the knock signal is the knock determination threshold value or less, a significant change that can be distinguished from the change of the signal by a disturbance does not appear in the knock signal. In this case, remaining processing is skipped, and the present subroutine is ended.

When the magnitude of the knock signal is larger than the knock determination threshold value, processing in step S25 is performed. In step S25, a time point at which the magnitude of the knock signal exceeds the knock determination threshold value is acquired as the knock occurrence timing (T_{NKst}).

According to the above subroutine, the knock determination threshold value is automatically changed in accordance with a magnitude of the disturbance applied to the knock signal, so that the signal by the disturbance and the signal by the vibration of self-ignition combustion can be accurately distinguished, and the knock occurrence timing can be acquired with high precision.

### 5. Third Embodiment

Next, a third embodiment of the present application is described. The third embodiment also has a feature in the method for acquiring the knock occurrence timing. In the third embodiment, as the method for acquiring the knock occurrence timing, a method based on a waveform of a knock signal is used, unlike the first and the second embodiments.

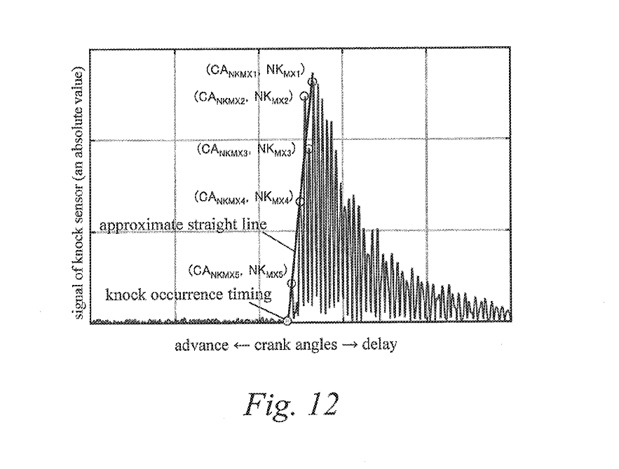

According to the method according to the third embodiment, as illustrated in FIG. 12, in an orthogonal coordinate system with an absolute value of the knock signal as a Y axis, and a crank angle as an X axis, a plurality of maximum points in a period that is at the advance side from the knock amplitude maximum timing (CA_{NKMX1}), and in a period in which it is certain that self-ignition combustion occurs are taken. The period in which it is certain that self-ignition combustion occurs can be determined from the magnitude of the knock signal, for example. In the example illustrated in FIG. 12, five maximum points including a maximum point corresponding to the knock amplitude maximum timing (CA_{NKMX1}) are taken. An approximate straight line approximating a relationship of the maximum points can be drawn by the least square method, for example, based on coordinates of the five maximum points (CA_{NKMX1}, NK_{MX1}), (CA_{NKMX2}, NK_{MX2}), (CA_{NKMX3}, NK_{MX3}), (CA_{NKMX4}, NK_{MX4}) and (CA_{NKMX5}, NK_{NX5}), by the least square method, for example. The control device 30 according to the third embodiment acquires an X value of an intersection point of the approximate straight line and the X axis as the knock occurrence timing.

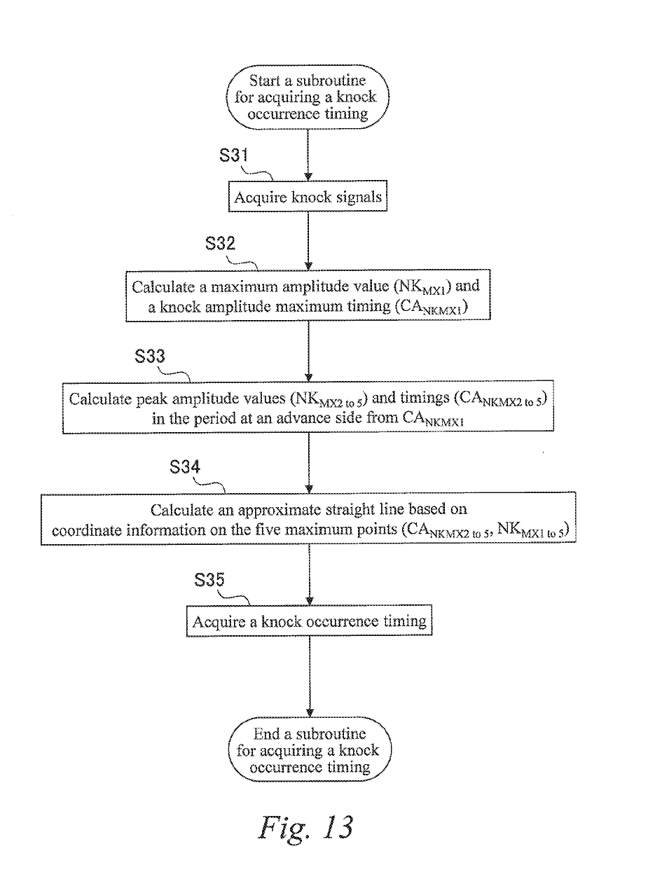

FIG. 13 is a flowchart illustrating a subroutine for acquiring the knock occurrence timing. The subroutine is called in the main routine of the self-ignition start timing feedback control. The main routine is common to the second embodiment and is illustrated in FIG. 10. In the memory of the control device 30 according to the third embodiment, the program corresponding to the main routine illustrated in FIG. 10 and a program corresponding to the subroutine illustrated in FIG. 13 are stored. These programs are executed by the processor, whereby a function for the self-ignition start timing feedback control is given to the control device 30.

In step S31 in the flowchart, knock signals are acquired from the knock sensor 10. The method for acquiring a knock signal is as described in step S21 in the flowchart according to the second embodiment.

In step S32, the maximum amplitude value (NK_{MX1}) of the knock signal and the knock amplitude maximum timing (CA_{NKMX1}) within the period in which the knock signals are acquired in step S31 are calculated.

In step S33, in a period at an advance side from the knock amplitude maximum timing (CA_{NKMX1}), peak amplitude values (NK_{MX2 to 5}) and timings (CA_{NKMX2 to 5}) of four maximum points are calculated. Together with the maximum amplitude value (NK_{MX1}) and the timing (CA_{NKMX1}) of the amplitude maximum point calculated in step S32, coordinate information on five maximum points in total is collected.

In step S34, based on the coordinate information on the five maximum points in total (CA_{NKMX1} so s, NK_{MX1 to 5}), the approximate straight line approximating the relationship of the maximum points by a linear function is calculated. Note that in place of the approximate straight line, an approximate curved line approximating the relationship of the maximum points by a quadratic function may be used.

In step S35, the X value of the intersection point of the approximate straight line or the approximate curved line, which is calculated in step S34, and the X axis, that is, a crank angle in the case of the value of the knock signal being set as zero in the approximate straight line or the approximate curved line is calculated. Subsequently, the calculated crank angle is acquired as the knock occurrence timing.

The knock occurrence timing acquired by the subroutine is read by the main routine, and is used in calculation of the self-ignition start timing. Note that the subroutine is executed by the knock occurrence timing acquisition unit 40.

According to the above subroutine, the timing at which a significant change appears in the knock signal, that is, the knock occurrence timing is estimated by using a knock signal after the significant change appears, instead of the knock signal before the significant change appears. The knock signal after the significant change appears has a high S/N ratio, so that according to the method, the influence of a disturbance on the precision of estimation of the knock occurrence timing can be suppressed to be low, and the influence of the disturbance on the precision of estimation of the self-ignition start timing can be suppressed to be low by extension.

### 6. Fourth Embodiment

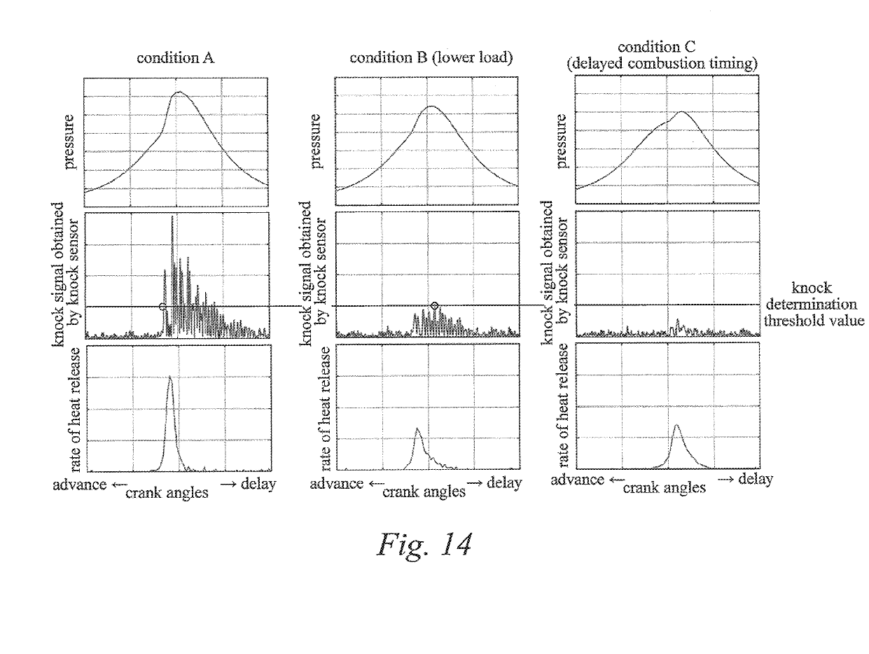

Next, a fourth embodiment of the present application is described. FIG. 14 is a diagram illustrating difference in level of a knock signal in accordance with operation conditions. A first tier in FIG. 14 is a graph illustrating a waveforms of in-cylinder pressure by self-ignition combustion. A second tier is a graph illustrating waveforms of knock signals obtained by the knock sensor. A third tier is a graph illustrating waveforms of rates of heat release calculated from the in-cylinder pressure. The respective graphs are prepared for each of conditions A, B and C. When the condition A is set as a reference condition, a load is lower in the condition B than in the condition A, and combustion timing is delayed more in the condition C than in the condition A.

The level of the knock signal changes dependently on a combustion speed. When the condition A and the condition B are compared, in the condition A with a relatively high load, the combustion speed is high and the level of the knock signal is high, whereas in the condition B with a relatively low load, the combustion speed is low and the level of the knock signal is also low. Further, when the condition A and the condition C are compared, in the condition A in which the combustion timing is relatively at the advance side, the combustion speed is high and the level of the knock signal is high, whereas in the condition C with a relatively low load, the combustion speed is low and the level of the knock signal is also low. When the level of a knock signal becomes low, the significant change appearing in the knock signal also becomes relatively unclear. Specifically, in the condition A, the knock occurrence timing at which the knock signal exceeds the knock determination threshold value is clear, whereas in the condition B, the knock occurrence timing at which the knock signal exceeds the knock determination threshold value becomes unclear. Further, in the condition C, the knock signal does not exceed the knock determination threshold value, and therefore the knock occurrence timing cannot be obtained.

Thus, in the fourth embodiment, a calculation method of the self-ignition start timing is changed based on the maximum amplitude value of the knock signal. Specifically, the control device 30 according to the fourth embodiment calculates the self-ignition start timing based on the knock occurrence timing as in the first to the third embodiments when the maximum amplitude value of the knock signal is larger than a predetermined lower limit value, but when the maximum amplitude value of the knock signal is the lower limit value or less, the control device 30 calculates the self-ignition start timing based on the knock amplitude maximum timing. This is because even in the case of the condition C, the amplitude of the knock signal becomes maximum at any timing. As compared with the correlation between the knock occurrence timing and the self-ignition start timing, the correlation between the knock amplitude maximum timing and the self-ignition start timing is not high. However, if the knock amplitude maximum timing is used only when the knock occurrence timing is unclear, it becomes possible to enlarge the operation region in which the self-ignition start timing feedback control can be carried out.

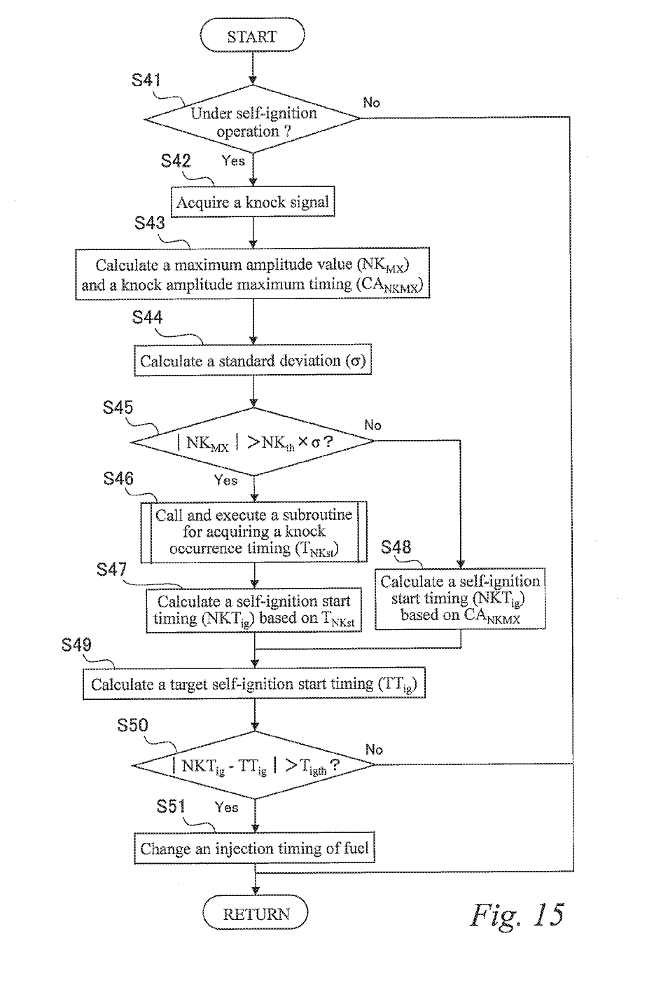

FIG. 15 is a flowchart illustrating the main routine of the self-ignition start timing feedback control according to the fourth embodiment. In the main routine, the subroutine for acquiring the knock occurrence timing is called. The subroutine is common to the second embodiment or the third embodiment, and is illustrated in FIG. 11 or FIG. 13. In the memory of the control device 30 according to the fourth embodiment, a program corresponding to the main routine illustrated in FIG. 15, and a program corresponding to the subroutine illustrated in FIG. 11 or FIG. 13 are stored. These programs are executed by the processor, whereby a function for the self-ignition start timing feedback control is given to the control device 30.

In step S41 in the flowchart, it is determined whether or not the internal combustion engine 2 is under self-ignition operation. The determination method is as described in step S1 in the flowchart according to the first embodiment. When the internal combustion engine 2 is not under self-ignition operation, the following processing is totally skipped and the present routine is ended.

When the internal combustion engine 2 is under self-ignition operation, processing from step S42 to step S44 is performed. In step S42, a knock signal is acquired from the knock sensor 10. The method for acquiring the knock signal is as described in step S21 in the flowchart according to the second embodiment.

In step S43, the maximum amplitude value (NK_{MX}) of the knock signal and the knock amplitude maximum timing (CA_{NKMX}) within the period in which the knock signal is acquired in step S42 are calculated.

In step S44, the standard deviation calculation period is determined with the knock amplitude maximum timing (CA_{NKMX}) calculated in step S43 as the reference. The standard deviation (σ) is calculated by statistically processing knock signals within the standard deviation calculation period.

Next, determination in step S45 is performed. In step S45, a value obtained by multiplying the standard deviation (σ) by the constant (NKₜₕ) is calculated as a lower limit value. Subsequently, it is determined whether or not the magnitude of the knock signal is larger than the lower limit value (NKₜₕ×σ). The constant (NKₜₕ) used here is larger than the constant (Kₜₕ) that is used in calculation of the knock determination threshold value.

When the magnitude of the knock signal is larger than the lower limit value, processing in steps 46 and S47 is performed. In step S46, the subroutine for acquiring the knock occurrence timing (T_{NKst}) is called and executed. Note that the processing in step S46 is performed by the knock occurrence timing acquisition unit 40.

In step S47, the self-ignition start timing (NKT_{ig}) is calculated based on the knock occurrence timing (T_{NKst}) calculated in step S46. The calculation method is as described in step S5 in the flowchart according to the first embodiment.

When the magnitude of the knock signal is the lower limit value or less, processing in step S48 is performed. In step S48, the self-ignition start timing (NKT_{ig}) is calculated based on the knock amplitude maximum timing (CA_{NKMX}) calculated in step S43. Calculation of the self-ignition start timing is performed by using the following expression, for example. In the expression, α1 and β1 are constants, and are determined by adaptation based on experimental results using actual machines. Note that the processing from step S42 to S45 and the processing in steps S47 and S48 are performed by the self-ignition start timing calculation unit 42.

NKT_{ig}=α1×CA_{NKMX}+β1+f(Engspd)

In step S49, the target self-ignition start timing (TT_{ig}) is calculated from the map. The content of the map is as described in step S6 in the flowchart according to the first embodiment.

Next, determination in step S50 is performed. In step S50, a control error between the self-ignition start timing (NKT_{ig}) calculated in step S47 or S48, and the target self-ignition start timing (TT_{ig}) calculated in step S49 is calculated, and it is determined whether or not the magnitude of the control error is larger than the correction control determination threshold value (T_{igth}). When the magnitude of the control error is the correction control determination threshold value or less, remaining processing is skipped and the present routine is ended.

When the magnitude of the control error exceeds the correction control determination threshold value, processing in step S51 is performed. The content of the processing is as described in step S8 in the flowchart according to the first embodiment. Note that the processing from step S49 to step S51 is performed by the actuator operation amount determination unit 44.

The above main routine is executed on a cycle basis for each cylinder of the internal combustion engine 2. However, there is a deviation of one cycle between the processing from step S41 to step S50 and the processing in step S51. The result of the processing from step S41 to step S50 executed in the cycle of this time is reflected in the processing of step S51 that is executed in a cycle of a next time.

### 7. Fifth Embodiment

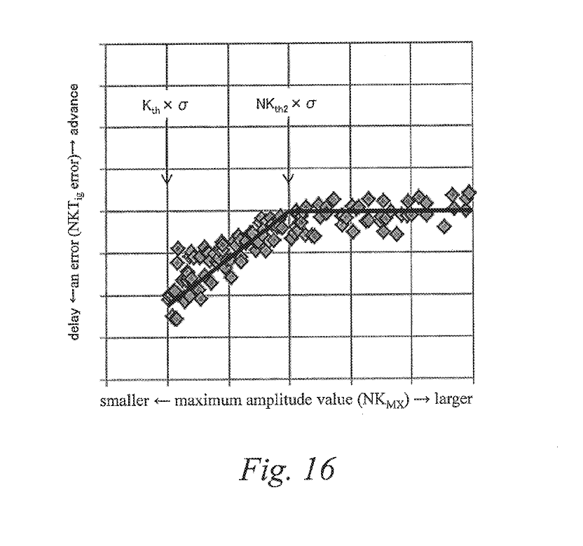

Next, a fifth embodiment of the present application is described. FIG. 16 is a graph illustrating a relationship between a maximum amplitude of a knock signal and an error of a calculated value of self-ignition timing to a true value, which is obtained from a result of an experiment using actual machines performed by the inventor according to the present application. As illustrated in the graph, it has been found that the calculated value of the self-ignition start timing deviates to a delay side from the true value when the maximum amplitude value (NK_{MX}) of the knock signal becomes lower than a certain lower limit value, and an error (NKT_{ig} error) thereof becomes larger, as the maximum amplitude value (NK_{MX}) of the knock signal becomes smaller.

Thus, in the fifth embodiment, the self-ignition start timing is corrected based on the maximum amplitude value of the knock signal. Specifically, when the maximum amplitude value of the knock signal is larger than a predetermined lower limit value, the control device 30 according to the fifth embodiment calculates the self-ignition start timing based on the knock occurrence timing as in the first to the third embodiments, whereas when the maximum amplitude value of the knock signal is the lower limit value or less, the control device 30 corrects the self-ignition start timing calculated based on the knock occurrence timing to the advance side, and makes the correction amount to the advance side, of the calculated value of the self-ignition start timing, larger as the maximum amplitude value of the knock signal is smaller. By performing correction like this, the error between the calculated value of the self-ignition start timing and the true value decreases, and precision of the self-ignition start timing feedback control is enhanced.

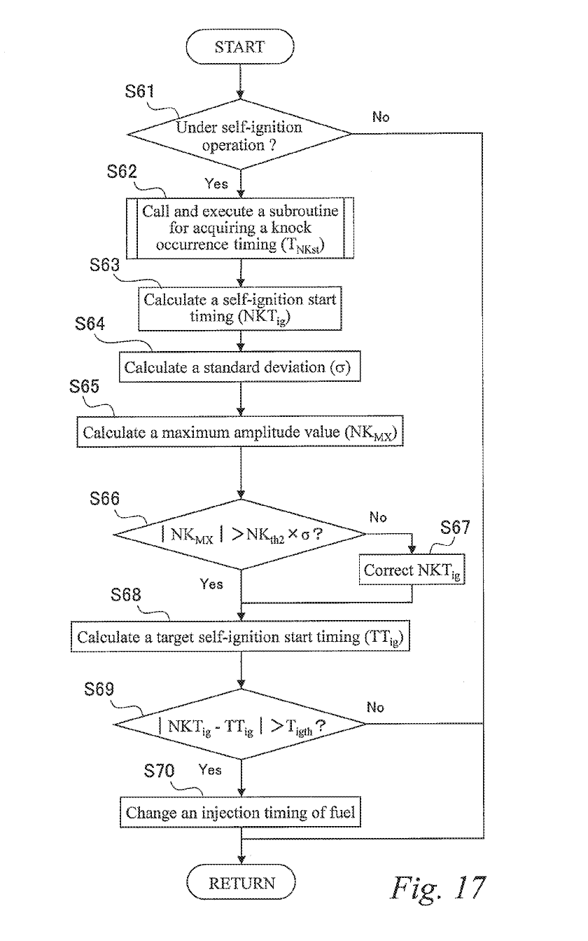

FIG. 17 is a flowchart illustrating the main routine of the self-ignition start timing feedback control according to the fifth embodiment. In the main routine, the subroutine for acquiring the knock occurrence timing is called. The subroutine is common to the second or third embodiment, and is illustrated in FIG. 11 or FIG. 13. In the memory of the control device 30 according to the fifth embodiment, a program corresponding to the main routine illustrated in FIG. 17, and the program corresponding to the subroutine illustrated in FIG. 11 or FIG. 13 are stored. These programs are executed by the processor, whereby a function for the self-ignition start timing feedback control is given to the control device 30.

In step S61 in the flowchart, it is determined whether or not the internal combustion engine 2 is under self-ignition operation. The determination method is as described in step S in the flowchart according to the first embodiment. When the internal combustion engine 2 is not under self-ignition operation, following processing is totally skipped and the present routine is ended.

When the internal combustion engine 2 is under self-ignition operation, processing from step S62 to step S65 is performed. In step S62, the subroutine for acquiring the knock occurrence timing (T_{NKst}) is called and executed. Note that the processing in step S62 is performed by the knock occurrence timing acquisition unit 40.

In step S63, the self-ignition start timing (NKT_{ig}) is calculated based on the knock occurrence timing calculated in step S62. The calculation method is as described in step S5 in the flowchart according to the first embodiment.

In step S64, the standard deviation (σ) is calculated by statistically processing the knock signals within the standard deviation calculation period. The calculation method of the standard deviation calculation period is as described in step S23 in the flowchart according to the second embodiment.

In step S65, the maximum amplitude value (NK_{MX}) of the knock signal is calculated.

Next, determination in step S66 is performed. In step S66, a value obtained by multiplying the standard deviation (σ) by the constant (NKₜₕ₂) is calculated as a lower limit value. Subsequently, it is determined whether or not the magnitude of the knock signal is larger than the lower limit value (NKₜₕ₂×σ). The constant (NKₜₕ₂) used here is larger than the constant (K) that is used in calculation of the knock determination threshold value.

When the magnitude of the knock signal is the lower limit value or less, processing in step S67 is performed. In step S67, the self-ignition start timing (NKT_{ig}) calculated in step S63 is corrected based on the relationship between the maximum amplitude value (NK_{MX}) of the knock signal and the error of the self-ignition start timing (NKT_{ig} error) illustrated in FIG. 16. As the maximum amplitude value of the knock signal is smaller than the lower limit value, the correction amount to the advance side, of the self-ignition start timing, is increased. Note that the processing from step S63 to step S67 is performed by the self-ignition start timing calculation unit 42.

In step S68, the target self-ignition start timing (TT_{ig}) is calculated from the map. The content of the map is as described in step S6 in the flowchart according to the first embodiment.

Next, determination in step S69 is performed. In step S69, a control error between the self-ignition start timing (NKT_{ig}) calculated in step S68 or the self-ignition start timing (NKT_{ig}) corrected in step S67, and the target self-ignition start timing (TT_{ig}) calculated in step S68 is calculated, and it is determined whether or not the magnitude of the control error is larger than the correction control determination threshold value (T_{igth}). When the magnitude of the control error is the correction control determination threshold value or less, remaining processing is skipped and the present routine is ended.

When the magnitude of the control error exceeds the correction control determination threshold value, processing in step S70 is performed. The content of the processing is as described in step S8 in the flowchart according to the first embodiment. Note that the processing from step S68 to step S70 is performed by the actuator operation amount determination unit 44.

The above main routine is executed on a cycle basis for each cylinder of the internal combustion engine 2. However, there is a deviation of one cycle between the processing from step S61 to step S69 and the processing in step S70. The result of the processing from step S61 to step S69 executed in the cycle of this time is reflected in the processing of step S70 that is executed in a cycle of a next time.

### 8. Other Embodiments

When the number of maximum points for approximating the approximate straight line or the approximate curved line is small in the third embodiment, it becomes difficult to acquire the knock occurrence timing with high precision from the approximate straight line or the approximate curved line. Consequently, when the predetermined number (three to five, for example) of maximum points cannot be obtained because the level of the knock signal is low, the calculation method of the self-ignition start timing may be changed based on the maximum amplitude value of the knock signal. Specifically, when the number of maximum points that can be acquired is the predetermined number or more, the self-ignition start timing is calculated based on the knock occurrence timing acquired by the method of the third embodiment, but when the number of maximum points that can be acquired is smaller than the predetermined number, the self-ignition start timing may be calculated based on the knock amplitude maximum timing.

Further, in the aforementioned embodiments, the actuator operation amount determination unit 44 determines the fuel injection timing that is the actuator operation amount for self-ignition occurrence timing feedback control, but the actuator operation amount determination unit 44 may determine the actuator operation amount of feed-forward control with the self-ignition occurrence timing as input.

What is claimed is:

1. A engine system comprising;
an internal combustion engine that causes premixed gas to burn by self-ignition,
a knock sensor installed in the internal combustion engine; and
a controller configured to take in and process the signal of a knock sensor;
wherein the controller programmed to
calculate a self-ignition start timing based on a timing at which a significant change appears in the signal of the knock sensor; and
determine an operation amount of an actuator for controlling an operation of the internal combustion engine based on the self-ignition start timing.

2. The engine system according to claim 1,
wherein the controller is programmed to acquire a timing at which a magnitude of the signal of the knock sensor exceeds a predetermined threshold value as the timing at which the significant change appears.

3. The engine system according to claim 2,
wherein the controller is programmed to calculate a variation of the signal of the knock sensor in a period in which it is certain that self-ignition combustion does not occur, and changes the threshold value in accordance with the variation of the signal of the knock sensor.

4. The engine system according to claim 3,
wherein the controller is programmed to determine a period in which the variation of the signal of the knock sensor is calculated with a timing at which an amplitude of the signal of the knock sensor becomes maximum, as a reference.

5. The engine system according to claim 1,
wherein the controller is programmed to
take a plurality of maximum points in a period that is at an advance side from a timing at which an amplitude of the signal of the knock sensor becomes maximum, and in a period in which it is certain that self-ignition combustion occurs, in an orthogonal coordinate system with a magnitude of the signal of the knock sensor as a Y axis, and with a crank angle or a time as an X axis; and
acquire an X value of an intersection point of a straight line or a curved line approximating a relationship among the plurality of maximum points, and the X axis, as the timing at which the significant change appears.

6. The engine system according to claim 1,
wherein the controller is programmed to
when a maximum value of an amplitude of the signal of the knock sensor is larger than a predetermined lower limit value,
calculate the self-ignition start timing based on the timing at which the significant change appears; and
when the maximum value is the lower limit value or less,
calculate the self-ignition start timing based on a timing at which the amplitude of the signal of the knock sensor becomes maximum.

7. The engine system according to claim 1,
wherein the controller is programmed to
when a maximum value of an amplitude of the signal of the knock sensor is a predetermined lower limit value or less,
correct the self-ignition start timing calculated based on the timing at which the significant change appears to an advance side, and
make a correction amount of the self-ignition start timing to the advance side larger, as the maximum value is smaller.
